(19) United States
(12) Patent Application Publication
(10) Pub. No.: US 2024/0272957 A1
(43) Pub. Date: Aug. 15, 2024

(54) CLOUD MANAGEMENT SYSTEM AND METHOD THEREFOR

(71) Applicant: Rising Cloud, LLC, Phoenix, AZ (US)

(72) Inventors: Derek Tolbert, Phoenix, AZ (US); Anthony Moran, Phoenix, AZ (US)

(73) Assignee: Rising Cloud, LLC, Phoenix, AZ (US)

(21) Appl. No.: 18/107,730

(22) Filed: Feb. 9, 2023

(51) Int. Cl. G06F 9/50; H04L 67/10

(52) U.S. Cl. CPC G06F 9/5072; H04L 67/10

(57) ABSTRACT

A cloud computing system has an external application program interface (API) allowing a user to access the cloud computing system and sending a job to at least one application. At least one application supervisor is provided, wherein each application supervisor monitors a specific application and deploys at least one cloud worker to the job. A database stores status information of the at least one cloud worker, job details and other telemetry data. An internal API is coupled to the database. A state machine receives the status information of the at least one cloud worker, job details and other telemetry data via the internal API. The state machine determines when servers need to be deleted, servers need to be created, when the at least one cloud worker needs to be deleted or additional cloud workers created.

### RELATED APPLICATIONS

This patent application is related to U.S. patent application Ser. No. 16/853,371, filed on Apr. 20, 2020, entitled “DYNAMICALLY ALLOCATED CLOUD WORKER MANAGEMENT SYSTEM AND METHOD” in the names of Narendran Muraleedharan and Clayton Brown, and which is incorporated herein by reference in its entirety.

### TECHNICAL FIELD

The present application generally relates to cloud computing and, more particularly, to an application management system for a cloud computing platform that is able to use data to anticipate the addition/deletion of workers/servers based on changing load conditions.

### BACKGROUND

Cloud computing is the on-demand availability of computer system resources, especially data storage and computer power, without direct active management by the user. The term is generally used to describe data centers available to many users over the Internet. Large clouds, predominant today, often have functions distributed over multiple locations from central servers. Clouds may be limited to a single organization (enterprise clouds), or be available to many organizations (public cloud).

Cloud computing relies on sharing of resources to achieve coherence and economies of scale. Cloud computing may allow companies to avoid or minimize up-front IT infrastructure costs. Cloud computing may allow companies to get their applications up and running faster, with improved manageability and less maintenance, and it may enable IT teams to more rapidly adjust resources to meet fluctuating and unpredictable demand.

Many business and operational processes such as document data extraction, image processing, compression, video rendering, speech-to-text conversion, machine learning predictions and the like can be packaged as compartmentalized or containerized software programs. These programs (henceforth referred to as cloud workers) may be deployed on servers hosted either on dedicated or shared machines, or through server management systems such as Amazon Web Services, Microsoft Azure, Google Cloud Platform, Packet, Vultr and the like.

Cloud workers may be designed to perform specific tasks on demand or from a queue. Businesses may rent servers from providers to host their cloud workers, paying for periods of times servers are deployed. In order to handle traffic (number of requests to perform tasks), businesses may need to deploy multiple servers, and/or multiple instances of cloud workers. Many times, businesses may not need to serve heavy traffic during off hours however continue to pay for server rentals.

The tasks performed by the cloud workers may be quick and take a few milliseconds, or may require heavy computational resources and take minutes to days. Because of this, cloud computing platforms need to be responsive to changing load conditions. Unfortunately, most cloud computing platforms are slow to react to changing load conditions

Therefore, it would be desirable to provide a system and method that overcome the above problems. The system and method must be able to use data to anticipate the addition/deletion of workers/servers of the cloud computing platform based on changing load conditions.

### SUMMARY

In accordance with one embodiment, a cloud computing system is disclosed. The cloud computing system has an external application program interface (API) allowing a user to access the cloud computing system and sending a job to at least one application. At least one application supervisor is provided, wherein each application supervisor monitors a specific application and deploys at least one cloud worker to the job. A database stores status information of the at least one cloud worker, job details and other telemetry data. An internal API is coupled to the database. A state machine receives the status information of the at least one cloud worker, job details and other telemetry data via the internal API. The state machine determines when servers need to be deleted, servers need to be created, when the at least one cloud worker needs to be deleted or additional cloud workers created.

In accordance with one embodiment, a cloud computing system is disclosed. The cloud computing system has an external application program interface (API) allowing a user to access the cloud computing system and sending a job to at least one application. A plurality of application supervisors are provided, wherein each application supervisor monitors a specific application. A plurality of cloud workers are provided, wherein the plurality of cloud workers are divided into a plurality of groups of cloud workers, each group of cloud works associated with a specific application supervisor. A database stores status of the plurality of cloud workers, job details and other telemetry data. An internal API is coupled to the database. A state machine receives the status of the plurality of cloud workers, job details and other telemetry data via the internal API determining when servers need to be deleted or created and when the at least one cloud worker needs to be deleted or additional cloud workers created.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a block diagram of an exemplary embodiment of a scalable cloud computing platform according to one aspect of the present application;

FIG. 2 is a perspective view of an exemplary embodiment of a computing device used in the scalable cloud computing platform of FIG. 1 in accordance with one embodiment of the present invention;

FIG. 3 is an exemplary embodiment of an application management system used in the scalable cloud computing platform of FIG. 1 according to one aspect of the present application;

FIG. 4 is an exemplary embodiment of a multi-application management system for use in the scalable cloud computing platform of FIG. 1 according to one aspect of the present application; and

FIG. 5 is an exemplary embodiment of a single application management system for use in the scalable cloud computing platform of FIG. 1 according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary dynamic scalable cloud computing platform that is responsive to changing load conditions. The dynamic scalable cloud computing platform may use data to anticipate the addition/deletion of workers/servers of the cloud computing platform based on changing load conditions.

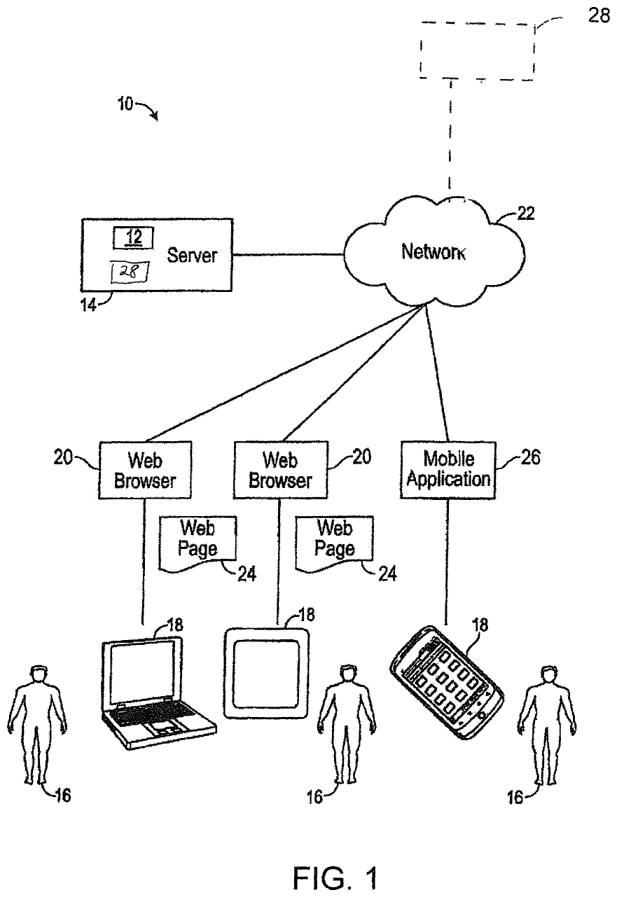

Referring now to FIG. 1, a cloud computing system 10 may be shown. The cloud computing system 10 may allow one to access a dynamic scalable cloud computing system 28 (hereinafter system 28) that is responsive to changing load conditions. The system 28 may use data to anticipate the addition/deletion of workers/servers based on changing load conditions.

The cloud computing system 10 may have a server 14. The server 14 may be used to host a platform 12. The platform 12 may allow one to access the system 28 of the present invention. Individuals 16 may use one or more computing devices 18 to access the platform 12 that may be hosted on the server 14. The computing devices 18 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like. The computing device 18 may be described in the general context of computer system executable instructions, such as program modules, being executed by a computer system as may be described below.

The computing device 18 may be loaded with an operating system. The operating system of the computing device 18 may manage hardware and software resources of the computing device 18 and provide common services for computer programs running on the computing device 18. The computing device 18 may be loaded with a browser 20. The browser 20 may allow the computing device 18 to gain access to a network 22 such as a Local Area Network (LAN), a Wide Area Network (WAN) or similar type of networks. The browser 20 may be a commercially available web browser Microsoft® Internet Explorer, Google® Chrome, Mozilla® Firefox, Apple® Safari, similar browsing applications, a remote network access software, or similar types of software for connecting to a network. By connecting to the network 22, the computing device 18 may access a webpage 24 associated with the platform 12 hosted on the server 14 thereby gaining access to use the system 28.

Alternatively, or in addition to, the computing device 18 may download a mobile application 26. The mobile application 26 may access and communicate with the platform 12 hosted on the server 14. By connecting to the network 22, the computing device 18 may access and communicate with the platform 12 hosted on the server 14 via the mobile application 26 thereby gaining access to the system 28

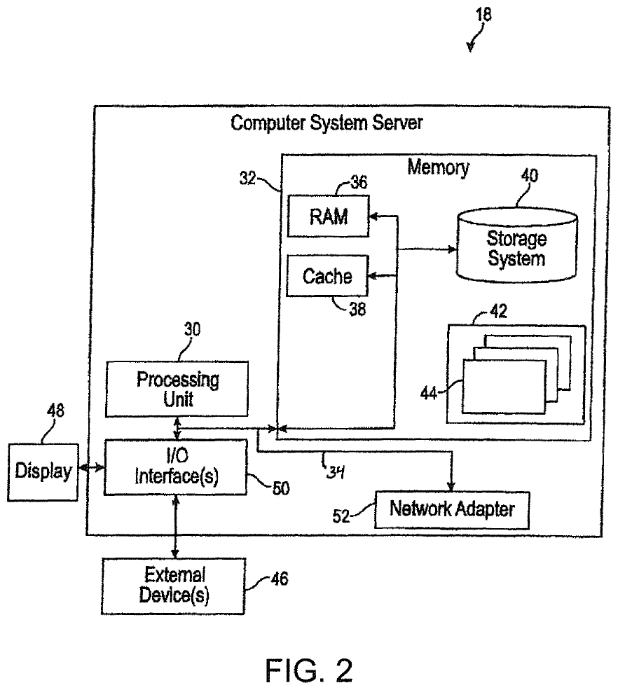

Referring now to FIG. 2, the server 14 and/or computing devices 18 (hereinafter computing device 18) may be described in more detail in terms of the machine elements that provide functionality to the systems and methods disclosed herein. The components of the computing devices 18 may include, but are not limited to, one or more processors or processing units 30, a system memory 32, and a system bus 34 that couples various system components including the system memory 32 to the processor 30. The computing devices 18 may typically include a variety of computer system readable media. Such media could be chosen from any available media that is accessible by the computing devices 18, including non-transitory, volatile and non-volatile media, removable and non-removable media. The system memory 32 could include one or more computer system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein. For example, the program modules 44 may carry out the steps for initiating an event creation, private and group communication between invitees to the event created, visual and/or textual summaries of past events of individuals and other functionality as will be described below.

The computing device 18 may communicate with one or more external devices 46 such as a keyboard, a pointing device, a display 48, and/or any similar devices (e.g., network card, modern, etc.) that enable the computing device 18 to communicate with the server 14 (FIG. 1). Such communication may occur via Input/Output (I/O) interfaces 50. Alternatively, the computing devices 18 may communicate with one or more networks such as a local area network (LAN), a general wide area network (WAN), and/or a public network (e.g., the network 22 shown in FIG. 1) via a network adapter 52. As depicted, the network adapter 52 may communicate with the other components of the computing device 18 via the bus 36.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

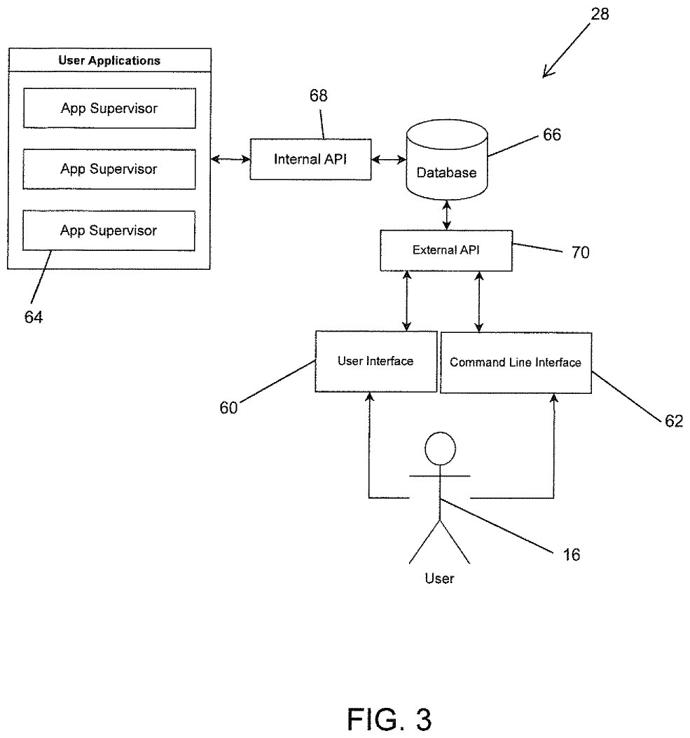

Referring to FIG. 3, a functional block diagram of the dynamic scalable cloud computing system 28 (hereinafter system 28) may be seen. While the system 28 may be part of the platform 12, it may be a separate block as shown in dotted lines in FIG. 1. As shown in FIG. 3, the individual 16 may access/interact with the system 28 via two different interfaces: (1) a browser-based user interface 60 and (2) a command line interface 62. A browser-based user interface (BUI) 60 may allow the individual 16 to interact with the system 28 via controls/menus located on a web browser 20. A command line interface (CLI) 62 may be a text-based interface that is used to operate the system 28 while allowing the individual 16 to respond to visual prompts by typing single commands into the interface and receiving a reply in the same way. In accordance with one embodiment, the browser-based user interface 60 may be a graphical user interface (GUI). The graphical user interface 60 may allow individuals 16 to manage all of their applications, manage application security, visualize application states, usage data, accumulated costs, deploy new applications, and manage user access. The CLI 62 may allow individuals 16 to manage all of their applications, manage security, and deploy new applications.

As may be seen in FIG. 3, the system 28 may use multiple application program interfaces (API) for communication to and within the system 28. The system may use an internal API 68 and an external API 70. An internal API 68 may be inaccessible to external consumers and only available to an organization's internal developers. An external API 70 can be enabled per tenant and enables individuals 16 to programmatically interact with features of the system 28 from their own controlled sites and systems.

The system 28 may have application supervisors 64 that may update a database 66 via an internal API 68 associated with the system 28. Individuals 16 may access the database 66 via an external API 70. This decoupling may ensure that the individuals 16 are only given access to the data they need and not those needed by the internal services within the system 28. In general, the database 66 may store data related to cloud worker statuses, job details as well as other data as will be described below.

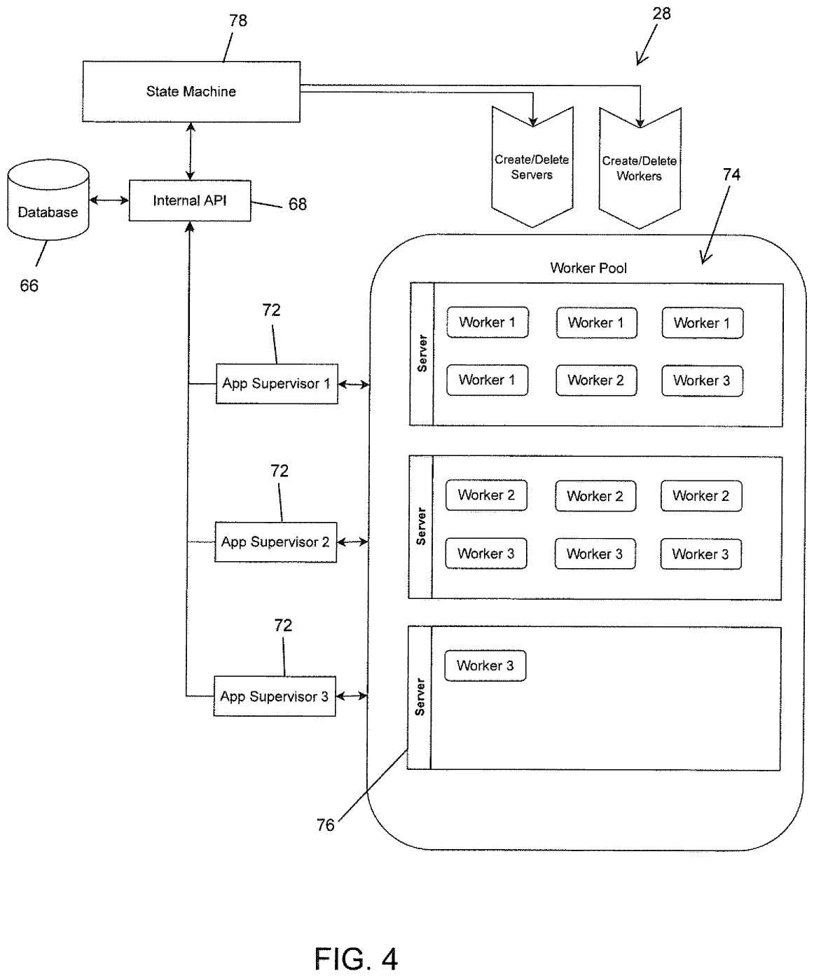

Referring to FIG. 4, the system 28 may be shown for use with multi-applications. While FIG. 3 may show the system 28 deploying three (3) applications, this is only shown as an example. The system 28 may manage any number of applications. Each application may consist of an app supervisor 72 and a set of cloud workers 74. The cloud workers 74 may be compartmentalized or containerized software programs that may perform a specific task. These tasks may be document data extraction, image processing, compression, video rendering, speech-to-text conversion, machine learning predictions, and similar processes. The cloud workers 74 may have Virtual Private Network (VPN) configurations in order to connect to single or multiple VPNs to secure data transmissions and allowing the system 28 to be used for sensitive and critical data and applications. Cloud workers 74 may generally be deployed on servers 76 via Virtual Machines (VM). Such deployment may require servers to be purchased or rented. This may result in server cost for times the cloud worker may be idling. The system 28 may be able to use data to anticipate the addition/deletion of workers/servers based on changing load conditions.

Each app supervisor 72 may be responsible for a set of cloud workers 74. For example, the app supervisor 72 labeled as #1 may be responsible for the set of cloud workers 74 labeled as #1. Similarly, the app supervisor 72 labeled as #2 may be responsible for the set of cloud workers 74 labeled as #2 and the app supervisor 72 labeled as #3 may be responsible for the set of cloud workers 74 labeled as #3.

When multiple applications exist, the cloud workers 74 of each app supervisor 72 may be dispersed across the server pool, i.e., across multiple servers 76. This allows the system 28 to save time and cost for the individual 16 by sharing resource space. Cloud workers 74 may be unaware of the other containerized instances running alongside themselves, and only communicate with the public network 22 and their respective app supervisor 72. Each app supervisor 72 may forward telemetry data to a state machine 78. In the present embodiment, each app supervisor 72 may forward telemetry data to a state machine 78 via the internal API 68. This may allow the state machine 78 to determine when servers 76 need to be deleted or created and when cloud workers 74 need to be created or deleted. As is demonstrated, the state machine 78 may attempt to fill a respective server 76 before provisioning resources on another. This may allow the system 28 to reduce overall cost by removing unneeded servers 76 as soon as possible. Additionally, the state machine 78 may be integrated with machine learning algorithms that may allow the state machine 78 to predict the future state of each app. This may allow the state machine 78 to add additional servers 76 in anticipation of their immediate need and ensure resources are available as the individual apps need them.

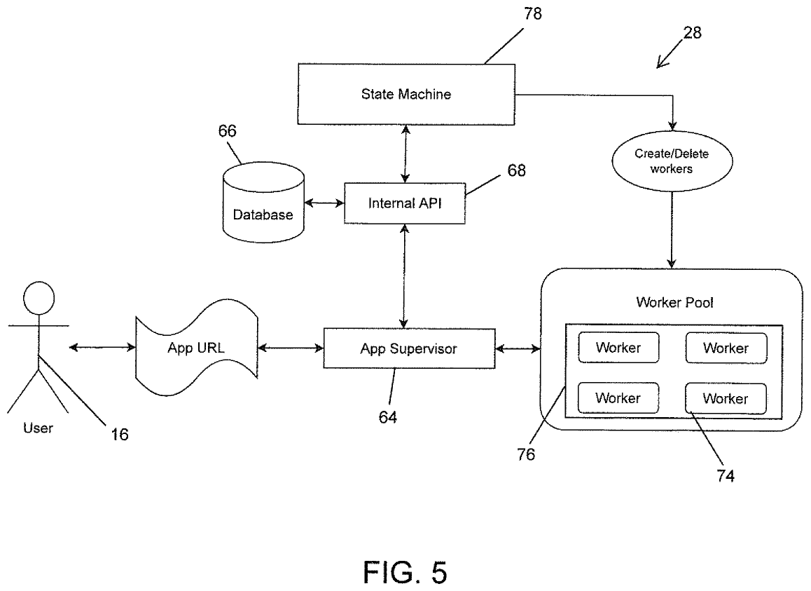

Referring now to FIG. 5, a block diagram of the system 28 may be shown for use with a single application. In this embodiment, the individual 16 may interact with a deployed application via a publicly accessible URL generated by the system 28. Unique URLs may be generated for each application to differentiate between all applications deployed on the cloud computing system 10. All HTTP traffic may be forwarded to the app supervisor 64, a proxy server which serves as the entry point for the user's application. The app supervisor 64 may balance HTTP requests over the cloud workers 74 in the worker pool and return responses back to the individual 16. A cloud worker 74 is an instance of the user's containerized application. Cloud workers 74 may be dynamically scaled as demand changes. The app supervisor 64 may forward telemetry data to the state machine 78 via the internal API 68. This may allow the state machine 78 to make decisions to create or delete cloud workers 74.

The foregoing description is illustrative of particular embodiments of the application, but is not meant to be a limitation upon the practice thereof. The following claims, including all equivalents thereof, are intended to define the scope of the application.

What is claimed is:

1. A cloud computing system comprising:
an external application program interface (API) allowing a user to access the cloud computing system and sending a job to at least one application;
at least one application supervisor, wherein each application supervisor monitors a specific application and deploys at least one cloud worker to the job;
a database storing status of the at least one cloud worker, job details and other telemetry data;
an internal API coupled to the database;
a state machine receiving the status of the at least one cloud worker, job details and other telemetry data via the internal API determining when servers need to be deleted, servers need to be created, when the at least one cloud worker needs to be deleted or additional cloud workers created.

2. The cloud computing system of claim 1, comprising a user interface coupled to the external API.

3. The cloud computing system of claim 2, comprising wherein the user interface is a browser based user interface.

4. The cloud computing system of claim 2, comprising wherein the user interface is a command line interface.

5. The cloud computing system of claim 1, comprising:
a plurality of application supervisors, wherein each application supervisor monitors a specific application; and
a plurality of cloud workers, wherein the plurality of cloud workers are divided into a plurality of groups of cloud workers, each group of cloud workers associated with a specific application supervisor.

6. The cloud computing system of claim 5, comprising a plurality of servers, wherein the plurality of cloud workers are distributed among the plurality of servers.

7. The cloud computing system of claim 6, wherein the state machine receives the status of the plurality of cloud workers, job details and other telemetry data via the internal API and determines whether additional servers need to be created, at least one of the plurality of servers needs to be deleted, at least one of the plurality of cloud workers need to be deleted or additional cloud workers needs to be created.

8. A cloud computing system comprising:
an external application program interface (API) allowing a user to access the cloud computing system and sending a job to at least one application;
a plurality of application supervisors, wherein each application supervisor monitors a specific application;
a plurality of cloud workers, wherein the plurality of cloud workers is divided into a plurality of groups of cloud workers, each group of cloud workers associated with a specific application supervisor;
a database storing status of the plurality of cloud workers, job details and other telemetry data;
an internal API coupled to the database;
a state machine receiving the status of the plurality of cloud workers, job details and other telemetry data via the internal API determining when servers need to be deleted or created and when the at least one cloud worker needs to be deleted or additional cloud workers created.

9. The cloud computing system of claim 8, comprising a user interface coupled to the external API.

10. The cloud computing system of claim 9, comprising wherein the user interface is a browser based user interface.

11. The cloud computing system of claim 9, comprising wherein the user interface is a command line interface.

12. The cloud computing system of claim 9, comprising a plurality of servers, wherein the plurality of cloud workers are distributed among the plurality of servers.

13. The cloud computing system of claim 12, wherein the state machine receives the status of the plurality of cloud workers, job details and other telemetry data via the internal API and determines whether additional servers need to be created, at least one of the plurality of servers needs to be deleted, at least one of the plurality of cloud workers need to be deleted, or additional cloud workers created.

14. A cloud computing system comprising:
an external application program interface (API) allowing a user to access the cloud computing system and sending a job to at least one application;
a user interface coupled to the external API;
a plurality of application supervisors, wherein each application supervisor monitors a specific application;
a plurality of cloud workers, wherein the plurality of cloud workers is divided into a plurality of groups of cloud workers, each group of cloud works associated with a specific application supervisor;
a plurality of servers, wherein the plurality of cloud workers are distributed among the plurality of servers;
a database storing status of the plurality of cloud workers, job details and other telemetry data;
an internal API coupled to the database; and
a state machine receiving the status of the plurality of cloud workers, job details and other telemetry data via the internal API determining whether additional servers need to be created, at least one of the plurality of servers needs to be deleted, at least one of the plurality of cloud workers need to be deleted, or additional cloud workers created.

15. The cloud computing system of claim 14, comprising wherein the user interface is a browser based user interface.

16. The cloud computing system of claim 14, comprising wherein the user interface is a command line interface.
